(19) United States
(12) Patent Application Publication
(10) Pub. No.: US 2022/0391792 A1
(43) Pub. Date: Dec. 8, 2022

(54) EXTRACTION DEVICE, EXTRACTION METHOD, AND EXTRACTION PROGRAM

(71) Applicant: Nippon Telegraph and Telephone Corporation, Tokyo (JP)

(72) Inventors: Yuki Urabe, Musashino-shi, Tokyo (JP); Kimio Tsuchikawa, Musashino-shi, Tokyo (JP); Takeshi Masuda, Musashino-shi, Tokyo (JP); Fumihiro YOKOSE, Musashino-shi, Tokyo (JP); Sayaka Yagi, Musashino-shi, Tokyo (JP)

(21) Appl. No.: 17/769,953

(22) PCT Filed: Oct. 30, 2019
(86) PCT No.: PCT/JP2019/042687

§ 371 Date: Apr. 18, 2022

(51) Int. Cl. G06Q 10/06; G06F 17/40

(52) U.S. Cl. CPC G06Q 10/0633; G06F 17/40

(57) ABSTRACT

For each of operations each included in at least one of a plurality of flow instances generated based on an operation log of a terminal, a counting unit (104) counts the number of flow instances each including the same operation. Also, the extraction unit (105) extracts operations included commonly in the flow instances the number of which is larger than a predetermined criterion as counted by the counting unit (104), in order of occurrence time.

### TECHNICAL FIELD

The present invention relates to an extraction device, an extraction method and an extraction program.

### BACKGROUND ART

For effective business operation improvement, techniques that assist a business analyst in correctly grasping an actual business operation status have been proposed. For example, techniques in which a flowchart is created from an operation log and displayed have been known (for example, Non-Patent Literature 1). Also, for example, a technique for specifying a main flow, which is an operation part frequently occurring common to a plurality of tasks, from flow instances (process instances) in which operations are arranged in order of occurrence time has been proposed. The main flow is conceivably a part to which RPA (robotic process automation) can effectively be applied.

### CITATION LIST

### Non-Patent Literature

Non-Patent Literature 1: Urabe, Yagi, Tsuchikawa, Masuda, Study of Business Process Visualization Method using Operation Log, IEICE Technical Report, vol. 118, no. 483, ICM2018-64, pp. 83-88, 2019.

### SUMMARY OF THE INVENTION

### Technical Problem

However, the conventional techniques have a problem in where there are a wide variety of operation flows, it may be difficult to extract a main flow from flow instances.

Here, in the conventional techniques, in a task repeated performed, a flow instance is prepared for each case from an operation log acquired from a terminal, and types, and numbers of occurrences, of flow instances are specified, and based on a threshold value set by a user, a flow instance falling within the threshold value is determined as a main flow and a flow instance not falling within the threshold value is determined as an exceptional flow.

More specifically, for example, it is assumed that there are 100 flow instances that are divided into seven categories. At this time, according to the conventional techniques, if the user sets the threshold value as 2, from among the seven types of flow instances, two types of flow instances whose respective numbers of occurrences are larger are each determined as a main flow and the remaining five types of flow instances are each determined as an exceptional flow.

On the other hand, where there is a wide variety of operation flows, there are less likely to be perfectly matched flow instances, and thus, in the conventional techniques, it is originally difficult to categorize flow instances and there may be cases where no main flow can be extracted.

### Means for Solving the Problem

In order to solve the aforementioned problem and achieve an object, an extraction device includes: a generation unit that generates a plurality of operation sequences each including a plurality of operations based on an operation log of a terminal; a counting unit that, for each of operations included in the operation sequences, counts a number of operation sequences each including the same operation; and an extraction unit that extracts operations included commonly in the operation sequences the number of which is larger than a predetermined criterion as counted by the counting unit, in order of occurrence time.

### Effects of the Invention

The present invention enables, where there are a wide variety of operation flows, extracting a main flow from flow instances.

### BRIEF DESCRIPTION OF DRAWINGS

FIG. 1 is a diagram illustrating an example configuration of an extraction device according to a first embodiment.

FIG. 2 is a diagram illustrating an example of data acquired from an operation log.

FIG. 3 is a diagram illustrating an example of flow instances in Example 1.

FIG. 4 is a diagram illustrating example display of a main flow in Example 1.

FIG. 5 is a diagram illustrating an example of flow instances in Example 2.

FIG. 6 is a diagram illustrating example display of a main flow in Example 2.

FIG. 7 is a flowchart illustrating an overall flow of processing in an extraction device.

FIG. 8 is a flowchart illustrating a flow of processing for extracting a main flow.

FIG. 9 is a diagram illustrating an example of a computer that executes an extraction program.

### DESCRIPTION OF EMBODIMENTS

Embodiments of an extraction device, an extraction method and an extraction program according to the present application will be described in detail below with reference to the drawings. Note that the present invention is not limited by the below-described embodiments.

### Configuration of First Embodiment

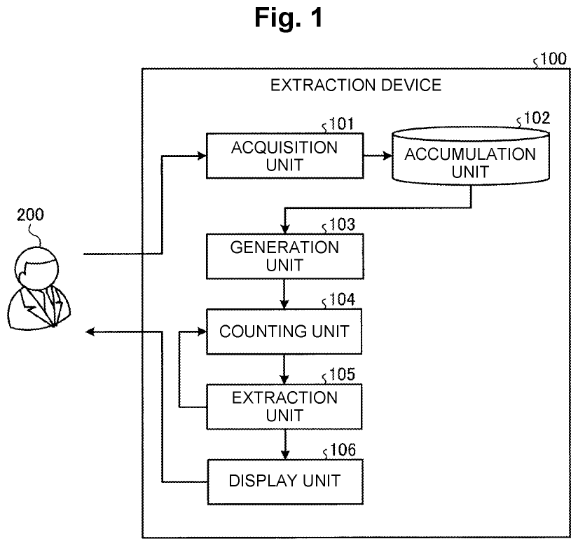

First, a configuration of an extraction device according to a first embodiment will be described with reference to FIG. 1. FIG. 1 is a diagram illustrating an example of the configuration of the extraction device according to the first embodiment. As illustrated in FIG. 1, an extraction device 100 includes an acquisition unit 101, an accumulation unit 102, a generation unit 103, a counting unit 104, an extraction unit 105 and a display unit 106. Also, the extraction device 100 is capable of inputting/outputting data from/to a terminal such as a PC (personal computer) that a user 200 operates.

The acquisition unit 101 acquires an operation log of the terminal. The acquisition unit 101 stores the acquired operation log in the accumulation unit 102. For example, the accumulation unit 102 is a storage device for accumulating data.

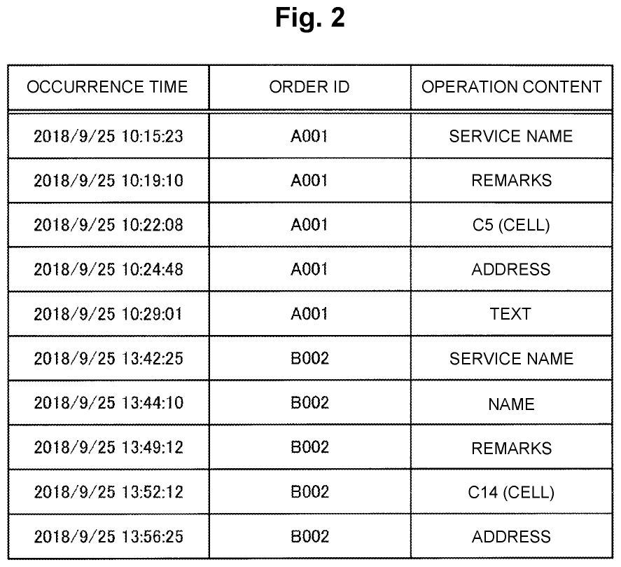

Data acquired by the acquisition unit 101 will be described with reference to FIG. 2. FIG. 2 is a diagram illustrating an example of data acquired from an operation log. As illustrated in FIG. 2, the data includes occurrence times, order IDs and operation contents. Each occurrence time is a time and date when an operation was performed. Each order ID is information for identifying a case or the like the operation handles. Each operation content is a content of the operation.

Examples of work in the present embodiment includes, e.g., order acceptance work in which an input of an order received from a customer to a business operation system in a prescribed procedure is repeatedly performed. Also, for example, operations in order acceptance work are specified by input items. For example, the operation content “service name” in FIG. 2 corresponds to an operation of inputting a value to the input item “service name”. Also, for example, the operation content “C5 (cell)” in FIG. 2 corresponds to an operation of inputting a value to a cell named C5 on a worksheet of spreadsheet software.

Also, for example, an order ID in the order acceptance work is information for identifying a customer that placed the relevant order. The operations with the order ID “A001” in FIG. 2 all relate to order acceptance work for a same customer.

The generation unit 103 generates a plurality of operation sequences each including a plurality of operations based on the operation log of the terminal. Hereinafter, an operation sequence generated by the generation unit 103 may be referred to as flow instance. The generation unit 103 generates flow instances by aggregating data accumulated in the accumulation unit 102 based on the orders ID and arranging the aggregated data in order of occurrence time.

### Example 1

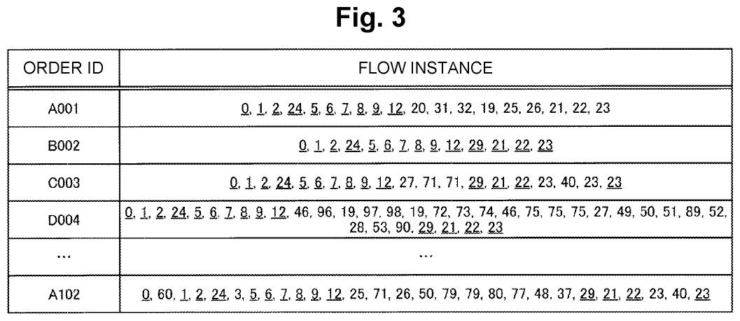

The subsequent processing will be described on an example-by-example basis. First, Example 1 will be described. FIG. 3 is a diagram illustrating an example of flow instances in Example 1. As illustrated in FIG. 3, each flow instance includes a plurality of operations for the relevant order ID. For example, the flow instance with the order ID “A001” includes operation 0, operation 1, operation 2, operation 24, operation 5, operation 6, operation 7, operation 8, operation 9, operation 12, operation 20, operation 31, operation 32, operation 19, operation 25, operation 26, operation 21, operation 22 and operation 23. Also, the operations in each flow instance in FIG. 3 are arranged in order of earliness of occurrence time.

Each of the numbers in FIG. 3 is a number for identifying an operation by a type of operation content. For example, operation 5 corresponds to an operation with the operation content “service name” in FIG. 2. Each number in FIG. 3 is determined based on the relevant operation content. For example, regardless of whether the order ID is “A001” or “B001”, an operation with the operation content “service name” is indicated as operation 5 in a flow instance.

For each of operations each included in at least one of the plurality of flow instances generated based on the operation log of the terminal, the counting unit 104 counts the number of flow instances each including the same operation. Also, the extraction unit 105 extracts operations included commonly in the flow instances the number of which is larger than a predetermined criterion as counted by the counting unit 104, in order of occurrence time. The operations extracted by the extraction unit 105 at this time form a main flow in the present embodiment.

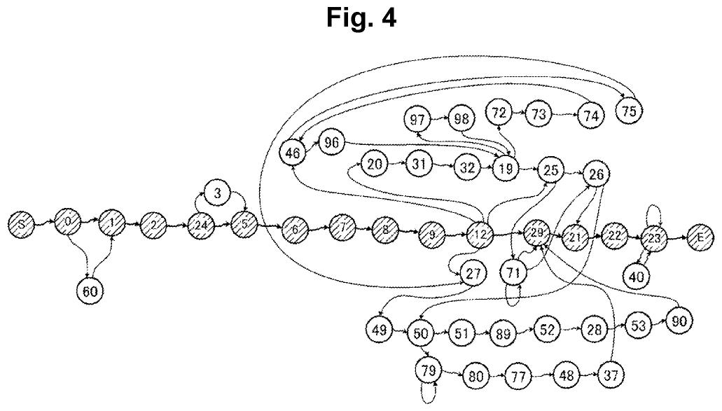

FIG. 4 is a diagram illustrating example display of the main flow in Example 1. The numbers in FIG. 4 correspond to the operation numbers in FIG. 3. As illustrated in FIG. 4, the extraction unit 105 extracts a main flow of “0, 1, 2, 24, 5, 6, 7, 8, 9, 12, 29, 21, 22, 23” from the flow instances in FIG. 3. In FIG. 3, the operations included in the main flow are underlined.

Here, the method for extracting the main flow will be described in detail. The extraction device 100 adds operations to a main flow by repeating a predetermined process. Here, first, processing in a first round will be described together with operation of the respective units and processing in a second round onwards will be described as necessary.

### First Round

First, the counting unit 104 focuses on an unextracted operation whose occurrence time is earliest in each flow instance. Then, the counting unit 104 counts the number of flow instances each including the focused operation. In the example in FIG. 3, the top in each of the flow instances is operation 0, and thus, in the first round, the counting unit 104 focuses on operation 0 and counts the number of flow instances each including operation 0 as 5.

In this way, for an operation not extracted by the extraction unit 105, an occurrence time of the operation being earliest, from among the operations included in each flow instance, the counting unit 104 counts the number of flow instances each including the same operation.

Here, the extraction unit 105 extracts an operation included commonly in the flow instances the number of which is largest and equal to or exceeding a predetermined criterion, and adds the operation to a main flow. For example, the extraction unit 105 extracts an operation included commonly in the flow instances the number of which is largest and equal to or exceeding 2. In the first round, the counting is performed for operation 0 alone, and thus, the extraction unit 105 adds operation 0 to a main flow.

In this way, each time the numbers of flow instances are counted by the counting unit 104, the extraction unit 105 extracts an operation included commonly in the flow instances the number of which is largest and equal to or exceeding the predetermined criterion as counted by the counting unit 104. If the respective numbers of flow instances counted for a plurality of operations have a same value and are equal to or exceeds the predetermined criterion, the extraction unit 105 extracts all of the plurality of operations. Also, if the respective numbers counted for all of operations are smaller than the predetermined criterion, the extraction unit 105 extracts none of the operations.

Then, the extraction unit 105 keeps the flow instances each including the extracted operation. In the first round, the extraction unit 105 keeps the flow instances with the order IDs “A001”, “B002”, “C003”, “D004” and “A102”.

However, the extraction unit 105 does not keep a flow instance not including an operation next to the extracted operation. Also, where the extraction unit 105 extracts no operation, the extraction unit 105 does not keep a flow instance including no operation following the focused operation. Also, for example, the extraction unit 105 can perform processing for keeping a flow instance by storing the orders ID in, e.g., an array and deleting the order ID of a flow instance not to be kept from the array.

The counting unit 104 determines whether or not the kept flow instances include an operation to be focused. Since the flow instances kept in the first round all include an operation following operation 0, the counting unit 104 determines that all of the kept flow instances include an operation to be focused.

### Second Round

Since the operations following operation 0 in the kept flow instances are operation 1 and operation 60, the counting unit 104 counts the number of flow instances each including operation 1 and the number of flow instances each including operation 60, respectively. In the example in FIG. 3, the counting unit 104 counts the number of flow instances each including operation 1 as 4 and counts the number of flow instances each including operation 60 as 1.

If there are a plurality of operations that are subjects of counting in one flow instance, the counting unit 104 takes the flow instance as the subject for counting considering that it includes an operation whose occurrence time is earlier. For example, the flow instance with the order ID “A102” includes both operation 1 and operation 60 and the occurrence time of operation 60 is earlier, the flow instance with the order ID “A102” is taken for counting as the flow instance including operation 60, not operation 1.

Since the number of flow instances each including operation 1 is larger than the number of flow instances each including operation 60 and is equal to or larger than the predetermined criterion, in the second round, the extraction unit 105 adds operation 1 to the main flow. Then, in the second round, the extraction unit 105 keeps the flow instances with the respective order IDs “A001”, “B002”, “C003”, “D004” and “A102”. Also, the main flow is “0, 1” at the time of an end of the second round.

### Eleventh Round

If the extraction device 100 repeats processing similar to the above in a third round onward, the main flow is “0, 1, 2, 24, 5, 6, 7, 8, 9, 12” at the time of an end of a tenth round. In an eleventh round, the counting unit 104 focuses on operation 20 and operation 29. Then, the counting unit 104 counts the number of flow instances each including operation 20 as 1 and counts the number of flow instances each including operation 29 as 4. Therefore, the extraction unit 105 extracts operation 29 and adds operation 29 to the main flow. Then, the extraction unit 105 keeps the flow instances with the respective order IDs “B002”, “C003”, “D004” and “A102” and does not keep the flow instance with the order ID “A001”.

Furthermore, the main flow is “0, 1, 2, 24, 5, 6, 7, 8, 9, 12, 29, 21, 22, 23” at the time of an end of a fourteenth round. At this time, the extraction unit 105 keeps none of the flow instances because there is no longer any operation to be focused. Therefore, the extraction device 100 ends the main flow extraction processing.

Note that there are a plurality of operations 23 that are subjects of extraction in the fourteenth round in the flow instance with the order ID “A102”. In such case, the extraction unit 105 extracts an operation whose occurrence time is later.

The display unit 106 outputs data via, e.g., display of a screen. The display unit 106 is, for example, a display device such as a display. The display unit 106 displays the operations included in the flow instances in a predetermined manner with the operations extracted by the extraction unit 105 highlighted. For example, as illustrated in FIG. 4, the display unit 106 displays respective graphs indicating flow instances with the operations as nodes in such a manner that the graphs are superimposed on one another and the operations extracted by the extraction unit 105 are highlighted. For example, the display unit 106 may provide a predetermined pattern or a color to the nodes or lines between the nodes in the main flow.

### Example 2

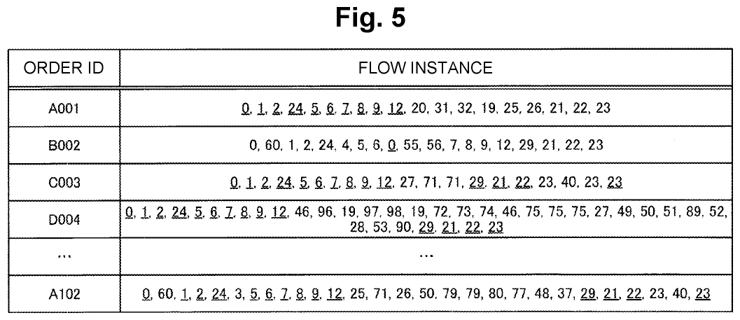

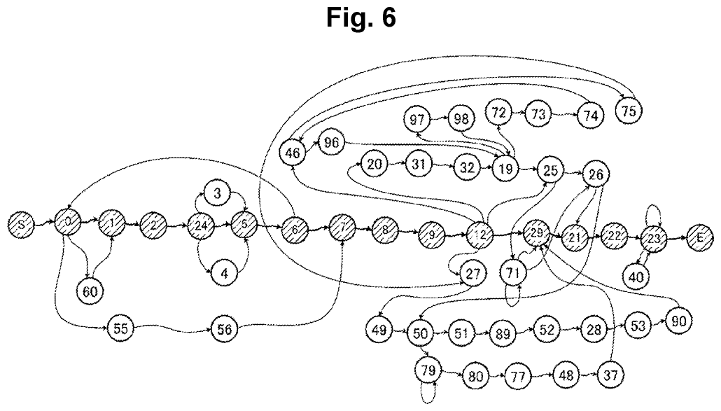

Example 2 that is different in operation log from Example 1 will be described. FIG. 5 is a diagram illustrating an example of flow instances in Example 2. FIG. 6 is a diagram illustrating example display of a main flow in Example 2. As illustrated in FIG. 5, Example 2 is different from Example 1 in operations included in a flow instance with the order ID “B002”.

As in Example 1, in a first round, the extraction unit 105 extracts operation 0, which is an operation included commonly in the flow instances the number of which is largest and equal to or exceeding a predetermined criterion. Here, the flow instance with the order ID “B002” includes two “operation 0”s. As described above, if there are a plurality of same operations that are subjects of extraction, the extraction unit 105 extracts an operation whose occurrence time is later. Therefore, in the first round, attention is paid to later operation 0 in the flow instance with the order ID “B002”. Then, in a second round, there is not operation 1 subsequent to focused operation 0, the extraction unit 105 does not keep the flow instance with the order ID “B002” to a third round onwards.

### Processing in First Embodiment

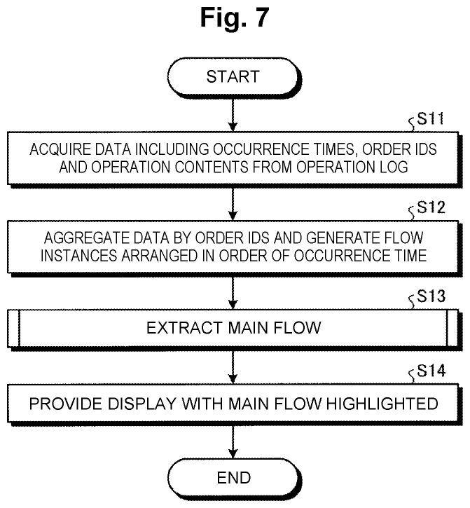

An overall flow of processing in the extraction device 100 will be described with reference to FIG. 7. FIG. 7 is a flowchart illustrating an overall flow of processing in the extraction device. As illustrated in FIG. 7, first, the extraction device 100 acquires data including occurrence times, order IDs and operation contents from an operation log (step S11). Next, the extraction device 100 aggregates the data by order IDs and generates flow instances in which the data are arranged in order of occurrence time (step S12).

Here, the extraction device 100 extracts a main flow from the flow instances (step S13). Then, the extraction device 100 provides display with the extracted main flow highlighted (step S14).

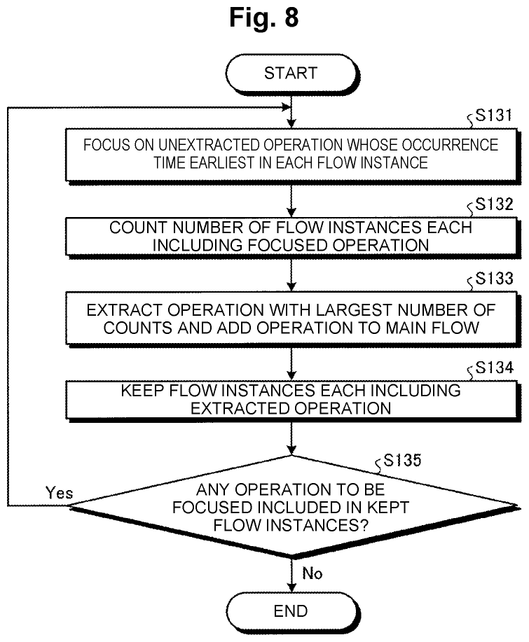

A flow of processing for extracting a main flow (step S13 in FIG. 7) will be described with reference to FIG. 8. FIG. 8 is a flowchart illustrating a flow of processing for extracting a main flow. As illustrated in FIG. 8, first, the extraction device 100 focuses on an unextracted operation whose occurrence time is earliest in each flow instance (step S131). Then, the extraction device 100 counts the number of flow instances each including the focused operation (step S132).

Here, the extraction device 100 extracts an operation included commonly in the flow instances the number of which is largest, and adds the operation to the main flow (step S133). Then, the extraction device 100 keeps flow instances each including the extracted operation (step S134).

The extraction device 100 determines whether or not an operation to be focused is included in the kept flow instances (step S135). If an operation to be focused is included (step S135: Yes), the extraction device 100 returns to step S131 and repeats the processing. On the other hand, if no operation to be focused is included (step S135: No), the extraction device 100 ends the processing.

### Effects of First Embodiment

As described above, for each of operations each included in at least one of a plurality of flow instances generated based on an operation log of a terminal, the counting unit 104 counts the number of flow instances each including the same operation. Also, the extraction unit 105 extracts operations included commonly in the flow instances the number of which is larger than a predetermined criterion as counted by the counting unit 104, in order of occurrence time. In this way, the extraction device 100 can extract a main flow even if there are no perfectly matched flow instances or even if operations in the main flow are distant from each other. As a result, the extraction device 100 is capable of even where there is a wide variety of operation flows, extracting a main flow from flow instances.

Also, for an operation not extracted by the extraction unit 105, an occurrence time of the operation being earliest, from among operations included in each flow instance, the counting unit 104 counts the number of flow instances each including the same operation. At this time, each time the numbers of flow instances are counted by the counting unit 104, the extraction unit 105 extracts an operation included commonly in the flow instances the number of which is largest as counted by the counting unit 104. In this way, the extraction device 100 automatically extracts a main flow by counting the numbers of flow instances.

The display unit 106 displays the operations included in the flow instances in a predetermined manner with operations extracted by the extraction unit 105 highlighted. Consequently, the user can intuitively grasp the main flow.

The display unit 106 displays respective graphs indicating flow instances with the operations as nodes in such a manner that the graphs are superimposed on one another and the operations extracted by the extraction unit 105 are highlighted. Consequently, the user can intuitively grasp a main flow.

### System Configuration, Etc.

Also, the components of the respective illustrated devices are function concepts and do not necessarily need to be physically configured as illustrated in the figures. In other words, specific forms of distribution and integration in the respective illustrated devices are not limited to those illustrated in the figures, and all or some of the forms can be functionally or physically configured in arbitrary unit in a distributed or integrated manner according to, e.g., various loads or usage. Furthermore, all or some of the respective processing functions executed in the respective devices can be implemented by a CPU (central processing unit) and programs analyzed and executed by the CPU or can be implemented in the form of hardware using wired logic.

Also, from among the processes described in the present embodiment, all or some of the processes described as being performed automatically can also be performed manually or all or some of the processes described as being performed manually can be performed automatically via a publicly known method. In addition, a user can arbitrarily change the processing procedures, the control procedures, the specific names and the information including various data and parameters that have been indicated in the above description and the figures except as specifically provided otherwise.

### Program

As an embodiment, the extraction device 100 can be implemented by an extraction program for executing the above-described extraction processing being installed on a desired computer in the form of package software or online software. For example, an information processing device can be made to function as the extraction device 100 by execution of the above-described extraction program by the information processing device. Examples of the information processing device mentioned here include desktop and laptop personal computers. Also, other examples of the information processing device include, e.g., mobile communication terminals such as a smartphone, a mobile phone and a PHS (personal handyphone system) and further include slate terminals such as a PDA (personal digital assistant).

Also, the extraction device 100 can be implemented by an extraction server device that where a terminal device that a user uses is a client, provides a service relating to the above-described extraction processing to the client. For example, the extraction server device is implemented by a server device that provides an extraction service in which an input of an operation log is received and an extracted main flow is output. In this case, the extraction server device may be implemented in the form of a Web server or may be implemented in the form of a cloud that provides a service relating to the above-described extraction processing via outsourcing.

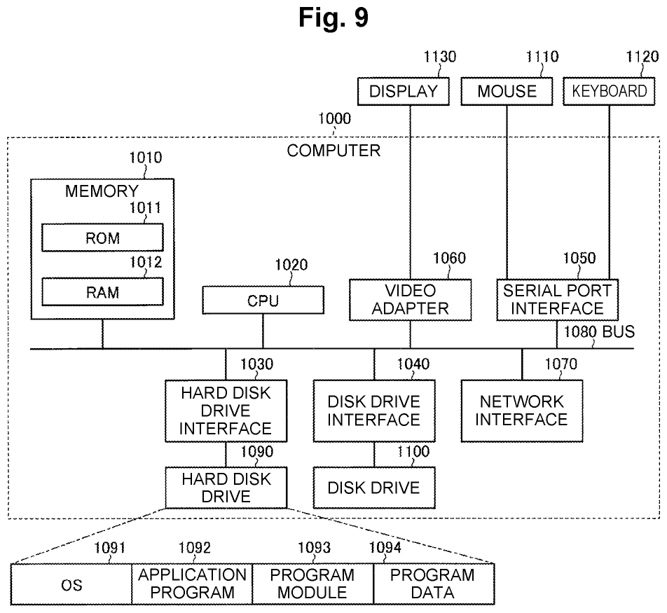

FIG. 9 is a diagram illustrating an example of a computer that executes the extraction program. The computer 1000 includes, for example, a memory 1010 and a CPU 1020. Also, the computer 1000 includes a hard drive disk interface 1030, a disk drive interface 1040, a serial port interface 1050, a video adapter 1060 and a network interface 1070. These components are connected via a bus 1080.

The memory 1010 includes a ROM (read-only memory) 1011 and a RAM (random access memory) 1012. The ROM 1011 stores, for example, a boot program such as a BIOS (basic input/output system). The hard drive disk interface 1030 is connected to a hard drive disk 1090. The disk drive interface 1040 is connected to a disk drive 1100. For example, a removable storage medium such as a magnetic disk or an optical disk is inserted to the disk drive 1100. The serial port interface 1050 is connected to, for example, a mouse 1110 and a keyboard 1120. The video adapter 1060 is connected to, for example, a display 1130.

The hard drive disk 1090 stores, for example, an OS (operating system) 1091, an application program 1092, a program module 1093 and program data 1094. In other words, programs for prescribing the respective processes in the extraction device 100 are implemented in the form of the program module 1093 in which computer-executable codes are written. The program module 1093 is stored in, for example, in the hard drive disk 1090. For example, a program module 1093 for performing processing that is similar to that performed by the functional components in the extraction device 100 is stored in the hard drive disk 1090. The hard drive disk 1090 may be substituted by an SSD.

Also, setting data used in the above-described processing in the embodiment are stored on, for example, the memory 1010 or the hard drive disk 1090 as the program data 1094. Then, the CPU 1020 reads the program module 1093 and the program data 1094 stored in the memory 1010 or the hard drive disk 1090 onto the RAM 1012 as necessary and executes the above-described processing in the embodiment.

The program module 1093 and the program data 1094 are not limited to being stored on the hard drive disk 1090, but may be stored on, for example, a removable storage medium and read by the CPU 1020 via, e.g., the disk drive 1100. Alternatively, the program module 1093 and the program data 1094 may be stored in another computer connected via a network (e.g., a LAN (local area network) or a WAN (wide area network)). Then, the program module 1093 and the program data 1094 may be read from the other computer by the CPU 1020 via the network interface 1070.

### REFERENCE SIGNS LIST

100 extraction device
101 acquisition unit
102 accumulation unit
103 generation unit
104 counting unit
105 extraction unit
106 display unit
200 user

1. An extraction device comprising:
a counting unit, including one or more processors, that, for each of operations included in at least one of a plurality of operation sequences generated based on an operation log of a terminal, counts a number of operation sequences each including a same operation; and
an extraction unit, including one or more processors, that extracts operations included commonly in the operation sequences, the number of which is larger than a predetermined criterion as counted by the counting unit, in order of occurrence time.

2. The extraction device according to claim 1, wherein:
for an operation not extracted by the extraction unit, an occurrence time of the operation being earliest from among the operations included in each operation sequence, the counting unit counts the number of operation sequences that each include the same operation; and
each time the numbers of operation sequences are counted by the counting unit, the extraction unit extracts an operation included commonly in the operation sequences for which the number is largest as counted by the counting unit.

3. The extraction device according to claim 1, further comprising a display unit, including one or more processors, that displays the operations included in the operation sequences in a predetermined manner with the operations extracted by the extraction unit are highlighted.

4. The extraction device according to claim 3, wherein the display unit displays respective graphs indicating the operation sequences with the operations as nodes in such a manner that the respective graphs are superimposed on each other and nodes corresponding to the operations extracted by the extraction unit are highlighted.

5. An extraction method comprising:
for each of operations each included in at least one of a plurality of operation sequences generated based on an operation log of a terminal, counting a number of operation sequences that each include a same operation;
for each of the operations included in the operation sequences, counting a number of the operation sequences that each include the same operation; and
extracting operations included commonly in the operation sequences for which the number is larger than a predetermined criterion as counted, in order of occurrence time.

6. A non-transitory computer readable medium comprising an extraction program for that causes a computer function as an extraction device by performing operations comprising:
for each of operations each included in at least one of a plurality of operation sequences generated based on an operation log of a terminal, counting a number of operation sequences that each include the same operation;
for each of the operations included in the operation sequences, counting a number of the operation sequences that each include the same operation; and
extracting operations included commonly in the operation sequences for which the number is larger than a predetermined criterion as counted, in order of occurrence time.
